(19) United States
(12) Patent Application Publication
(10) Pub. No.: US 2021/0331443 A1
(43) Pub. Date: Oct. 28, 2021

(54) LAMINATED SHEET FOR VEHICLE INTERIOR MATERIAL AND METHOD FOR MANUFACTURING THE SAME

(71) Applicants: Hyundai Motor Company, Seoul (KR); Kia Motors Corporation, Seoul (KR)

(72) Inventors: Hye Min Lee, Suwon (KR); Gun Kang, Seoul (KR); Myoung Ryoul Lee, Seoul (KR)

(21) Appl. No.: 17/027,040

(22) Filed: Sep. 21, 2020

(30) Foreign Application Priority Data
Apr. 23, 2020 (KR) 10-2020-0049288

(51) Int. Cl. B32B 5/24; B32B 5/02; B32B 5/18; B32B 9/02

(52) U.S. Cl. CPC B32B 5/245; B32B 5/026; B32B 5/18; B32B 9/025; B32B 2262/0284; B32B 2266/0235; B32B 2266/025; B32B 2262/062; B32B 2605/003; B32B 2250/05; B32B 2266/0278

(57) ABSTRACT

Disclosed are a laminated sheet for a vehicle interior material and a method for manufacturing the same. The laminated sheet not only includes a skin surface layer composed of a skin layer made of a liquid resin by using a casting method, thereby providing flexibility to the laminated sheet, but also includes a leather sheet layer and an intermediate layer which are bonded in a flame lamination method, thereby decreasing a peeling strength of the laminated sheet.

### CROSS-REFERENCE TO RELATED APPLICATION

This application claims under 35 U.S.C. § 119(a) the benefit of priority to Korean Patent Application No. 10-2020-0049288 filed on Apr. 23, 2020, the entire contents of which are incorporated herein by reference.

### TECHNICAL FIELD

The present invention relates to a laminated sheet for a vehicle interior material and a method for manufacturing the same, which improve the usage feeling such as drawability of a back pocket to be applicable even while removing wrinkles.

### BACKGROUND

In order to improve the usage feeling, that is, drawability of a back pocket, which is one of the existing sheets for a vehicle interior material, the back pocket has been used by inserting a rubber band into the sheet for the vehicle interior material. For example, when the rubber band is not inserted into the sheet serving as the back pocket, an elongation is insufficient, such that a process of inserting the rubber band is added to secure the opening amount of the back pocket. Further, there is a tendency to prevent the sheet from being stretched significantly by a process of adding polypropylene (PP) plate plastic to the central portion of the sheet which serves as the back pocket is added due to lack of restoration after the opening of the back pocket. However, the exterior design of the back pocket is not highly qualified due to the wrinkles of the rubber band contained in the sheet, and thus the improvement therefor is needed.

However, there is a problem in that when the rubber band is removed to improve the exterior design of the back pocket having low quality due to the wrinkles of the rubber band, the sheet serving as the back pocket is not sufficiently stretched, thereby causing a decrease in the usage feeling due to drawability. Accordingly, there is a need for a laminated sheet for a vehicle interior material and a method for manufacturing the same, which may secure the usage feeling due to the drawability even while removing the wrinkles.

The above information disclosed in this Background section is only for enhancement of understanding of the background of the invention and accordingly it may contain information that does not form the prior art that is already known in this country to a person of ordinary skill in the art.

### SUMMARY

In one preferred aspect, provided is a laminated sheet for a vehicle interior material. The laminated sheet may include: i) a backing cloth layer which contains a fiber having an adjusted diameter; ii) an intermediate layer which contains elastomer foam; and iii) a leather sheet layer which includes a skin surface layer composed of a skin layer made of a liquid resin, for example, by using a casting method and a fiber layer containing a mixed fiber having a high-stretch property. As such, usage feeling of a back pocket can be maintained while wrinkles caused by a rubber band or the like can be removed.

In one preferred aspect, provided is a method for manufacturing a laminated sheet for a vehicle interior material which is manufactured by bonding a backing cloth layer and a leather sheet layer to one surface and the other surface of an intermediate layer, respectively, in a flame lamination method.

The object of the present invention is not limited to the aforementioned objects. The object of the present invention will be more apparent from the following description, and will be realized by means described in the claims and combinations thereof.

A laminated sheet for a vehicle interior material may include: i) a backing cloth layer; ii) an intermediate layer which is positioned on the backing cloth layer and includes elastomer foam; and iii) a leather sheet layer which is positioned on the intermediate layer. The leather sheet layer may include a fiber layer, and a skin surface layer which is positioned on the fiber layer.

The fiber layer may include a mixed fiber including one or more types selected from the group consisting of poly trimethylene terephthalate (PTT) and poly ethylene terephthalate (PET).

The fiber layer may contain the mixed fiber having a mass ratio of the PTT and the PET of about 1:1 to 1.25.

The fiber layer may have a knitting density of about 30 to 35 pieces/inch.

The skin surface layer may include a skin layer to which a polyvinyl chloride (PVC) resin is applied, for example, in a casting method.

The skin surface layer may further include a foam layer which is positioned between the skin layer and the fiber layer, and a surface treatment layer which is positioned on the skin layer.

The leather sheet layer may have a thickness of about 1.2 to 1.5 mm, a static load elongation of about 80% or greater, and a tear strength of about 1.5 kgf or greater.

The elastomer foam may contain one or more types of resins selected from the group consisting of polyurethane (PU) and polypropylene (PP).

The intermediate layer may have a density of about 26 to 39.9 kg/m³, a tensile strength of about 80 kPa or greater, and an elongation of about 90% or greater.

The backing cloth layer may contain one or more types of fibers selected from the group consisting of polyester and cotton.

The thickness of the fiber may be about 10 to 20 denier.

The backing cloth layer may have a thickness of about 0.3 to 0.8 mm, a knitting density of about 20 to 35 pieces/inch, and an elongation of about 100% or greater.

The laminated sheet may further include a flame lamination bonding layer between the backing cloth layer and the intermediate layer.

The laminated sheet may have a load upon about 15% elongation of about 1.9 kgf or less, a static load elongation of about 80 to 100%, and a peeling strength between the leather sheet layer and the intermediate layer of about 0.4 kgf or less.

Further provided is a vehicle interior material including the laminated sheet as used herein. For example, the vehicle interior material may be used for producing or making a back pocket of a vehicle.

In an aspect, provided is a method for manufacturing a laminated sheet for a vehicle interior material. The method may include: preparing an intermediate layer, forming a backing cloth layer on one surface of the intermediate layer, and forming a leather sheet layer on the other surface of the intermediate layer. The leather sheet layer may be prepared by a step of preparing a fiber layer and a step of forming a skin surface layer on the fiber layer.

The forming of the skin surface layer may include: forming a foam layer on the fiber layer, forming a skin layer on the foam layer by applying a polyvinyl chloride (PVC) resin in a casting method, and forming a surface treatment layer by surface-treating the skin layer with a polyurethane-based surface treatment agent.

The casting method may cast the PVC resin on the foam layer in a thickness of about 0.15 to 0.50 mm, and the particle size of the PVC may be about 0.2 to 20 μm.

The forming of the backing cloth layer on one surface of the intermediate layer may form a flame lamination bonding layer on one surface of the intermediate layer in a flame lamination method to bond the backing cloth layer.

The forming of the leather sheet layer on the other surface of the intermediate layer may bond the leather sheet layer on the other surface of the intermediate layer in a flame lamination method.

The flame lamination method may be performed at a lamination speed of about 30 to 40 mm/min.

The laminated sheet for a vehicle interior material may include not only the skin surface layer composed of the skin layer made of the liquid resin by using the casting method, thereby providing flexibility to the laminated sheet but also the leather sheet layer and the intermediate layer which are bonded in the flame lamination method. As such, peeling strength of the laminated sheet may be reduced. Accordingly, the laminated sheet for the vehicle interior material may specifically set the method, the material, and the like, thereby clarifying the specifications to have the high sheet implementation reproducibility when the same sheet is manufactured later.

Further, the laminated sheet for the vehicle interior material having the features may be manufactured with ‘the load upon 15% elongation’ of 1.9 kgf or less objectively quantified in order to confirm the usage feeling of the back pocket, thereby improving the usage feeling such as the drawability and opening amount of the back pocket even while removing the wrinkles caused by the rubber band because of having no rubber band.

The effects of the present invention are not limited to the aforementioned effects. It should be understood that the effects of the present invention include all effects which may be inferred from the following description.

Other aspects of the invention are discussed infra.

### BRIEF DESCRIPTION OF THE DRAWINGS

The above and other features of the present invention will now be described in detail with reference to certain exemplary Examples thereof illustrated in the accompanying drawings which are given herein below by way of illustration only, and thus are not limitative of the present invention, and wherein:

FIG. 1 shows a cross-sectional diagram of an exemplary laminated sheet for a vehicle interior material according to an exemplary embodiment of the present invention.

FIG. 2 shows a flowchart for an exemplary method for manufacturing an exemplary laminated sheet for the vehicle interior material according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, positions, and shapes will be determined in section by the particular intended application and use environment.

In the figures, reference numbers refer to the same or equivalent sections of the present invention throughout the several figures of the drawing.

### DETAILED DESCRIPTION

As described above, objects, other objects, features, and advantages according to the present invention will be readily understood through the following preferred Examples associated with the accompanying drawings. However, the present invention is not limited to the Examples described herein and may also be embodied in other forms. Rather, the Examples introduced herein are provided so that the invention may be made thorough and complete, and the spirit according to the present invention may be sufficiently conveyed to those skilled in the art.

In this specification, it should be understood that terms such as “comprise” or “have” are intended to indicate that there is a feature, a number, a step, an operation, a component, a part, or a combination thereof described on the specification, and do not exclude the possibility of the presence or the addition of one or more other features, numbers, steps, operations, components, parts, or combinations thereof in advance. Further, when a portion such as a layer, a film, an area, or a plate is said to be “on” another portion, this includes not only the case “directly above” another portion but also other portions therebetween. Conversely, when a portion such as a layer, a film, an area, or a plate is said to be “under” another portion, this includes not only the case “directly under” another portion but also other portions therebetween.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values. Further, where a numerical range is disclosed herein, such a range is continuous, and includes unless otherwise indicated, every value from the minimum value to and including the maximum value of such a range. Still further, where such a range refers to integers, unless otherwise indicated, every integer from the minimum value to and including the maximum value is included.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the present specification, if a range is described for a variable, it will be understood that the variable includes all values within the described range including the described endpoints of the range. For example, it will be understood that a range of “5 to 10” includes not only values of 5, 6, 7, 8, 9, and 10 but also any sub-range such as 6 to 10, 7 to 10, 6 to 9, and 7 to 9, and also includes any value between reasonable integers within the scope of the described ranges such as 5.5, 6.5, 7.5, 5.5 to 8.5, 6.5 to 9, and the like. Further, it will be understood that a range of “10% to 30%” includes, for example, not only all integers including values, such as 10%, 11%, 12%, and 13%, and 30% but also any sub-range such as 10% to 15%, 12% to 18%, and 20% to 30%, and also includes any value between reasonable integers within the scope of the described range, such as 10.5%, 15.5%, and 25.5%.

It is understood that the term “vehicle” or “vehicular” or other similar term as used herein is inclusive of motor vehicles in general such as passenger automobiles including sports utility vehicles (operation SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Laminated Sheet for a Vehicle Interior Material

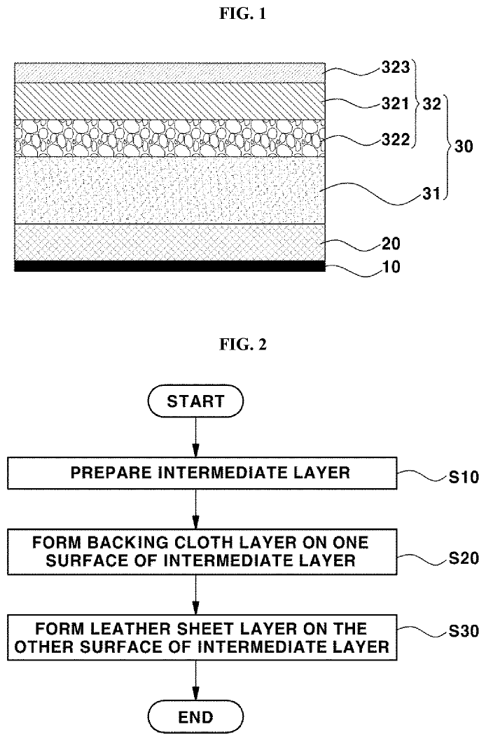

FIG. 1 is a cross-sectional diagram schematically illustrating a laminated sheet 1 for a vehicle interior material according to an exemplary embodiment of the present invention. As shown in FIG. 1, the laminated sheet 1 for the vehicle interior material includes a backing cloth layer 10; an intermediate layer 20 which is positioned on the backing cloth layer 10, and contains elastomer foam; and a leather sheet layer 30 which is positioned on the intermediate layer, and the leather sheet layer 30 includes a fiber layer 31, and a skin surface layer 32 which is positioned on the fiber layer.

The laminated sheet 1 for the vehicle interior material according to an exemplary embodiment of the present invention is not particularly limited as long as it is a sheet which has no wrinkles caused by not containing a rubber band, thereby improving the usage feeling such as drawability even while implementing high qualification of the appearance design.

(1) Backing Cloth Layer

The backing cloth layer 10 is not particularly limited as long as it does not decrease an elongation in a direction of fastening the fiber layer 31 which is included in the following leather sheet layer 30, thereby securing elasticity and a restoring force of the laminated sheet 1 for the vehicle interior material.

The backing cloth layer 10 may contain one or more types of fibers selected from the group consisting of typical materials which may be used for the backing cloth layer, for example, polyester, cotton, polypropylene, rayon, and nylon, and is not limited to containing a specific material, but preferably contains polyester which is suitable for the temperature of the flame lamination method, contributes to the shape stability of the product with filament yarn, and is cost-competitive.

After the intermediate layer 20 and the fiber layer 31 are bonded, the elongation in the direction of fastening the fiber layer 31 may be changed depending upon the thickness of the fiber contained in the backing cloth layer 10 according to an exemplary embodiment of the present invention. This is because the thicker the thickness, the greater the density of the backing cloth layer 10, thereby decreasing the elongation in the direction of fastening the fiber layer 31. Accordingly, the thickness of the fiber contained in the backing cloth layer 10 may be about 10 to 20 denier. When the thickness is less than about 10 denier, sagging may occur when the object is mounted to the back pocket, and when the thickness is greater than about 20 denier, the skin material elongation is decreased, thereby decreasing the usability of a component. Accordingly, the backing cloth layer 10 may include the fiber within a range of the thickness, thereby not decreasing the elongation in the direction of fastening the fiber layer 31 which is contained in the leather sheet layer 30.

Meanwhile, the backing cloth layer 10 may have a thickness of about 0.3 to 0.8 mm, a knitting density of about 20 to 35 pieces/inch, and an elongation of about 100% or greater and about 150% or less. Further, when the thickness is less than about 0.3 mm, the shape stability of the component may be decreased, and when the thickness is greater than about 0.8 mm, the usage feeling may be decreased by a decrease in the elongation of the laminated sheet. Further, when the knitting density is less than about 20 pieces/inch, the shape stability of the component may be decreased, and when the knitting density s greater than about 35 pieces/inch, a bonding strength between the backing cloth layer and the intermediate layer may be increased by a high surface area to decrease the elongation of a skin layer, thereby decreasing the usage feeling of the component. Further, when the elongation is less than about 100%, the opening amount of the component may be decreased, and when the elongation is greater than about 150%, sagging may occur when the object is mounted to the back pocket.

Further, the present invention may further provide a flame lamination bonding layer between the backing cloth layer and the intermediate layer below. The flame lamination bonding layer may be a layer which is formed by melting a part of the elastomer foam of the following intermediate layer with flame.

(2) Intermediate Layer

The intermediate layer 20 may be positioned on the backing cloth layer 10 and is not particularly limited as long as it may contain a material which may contain elastomer foam, and may be bonded to the fiber layer 31 of the leather sheet layer 30 below to maintain an appropriate peeling strength.

The intermediate layer 20 may contain one or more types of materials selected from the group consisting of typical materials which may be used for the intermediate layer in the present invention, for example, polyurethane (PU), polypropylene (PP), cotton, nylon, and rayon, and is not limited to containing a specific material. Preferably, the intermediate layer 20 may include polyester which is suitable for the temperature of the flame lamination process, thereby contributing to the shape stability of the product with the filament yarn, and may be cost-competitive.

With regard to the intermediate layer 20, the intermediate layer 20 and the fiber layer 31 may be bonded according to the lamination method, and then the elongation in the direction of fastening the fiber layer 31 may be changed. This is because as the bonding strength between the intermediate layer 20 and the fiber layer 31 increases, the laminated sheet 1 for the vehicle interior material may decrease the usage feeling such as drawability. Accordingly, as the lamination method, one or more types selected from the group consisting of a flame lamination method, a thermoplastic PU lamination method, and a thermosetting PU lamination method may be selected, and is not limited to a specific method, but preferably uses the flame lamination method which may manufacture the laminated sheet 1 for the vehicle interior material with ‘the load upon 15% elongation’ of 1.9 kgf or less objectively quantified by the present invention in order to confirm the usage feeling such as drawability. For example, the intermediate layer 20 may be bonded to the fiber layer 31 below in the flame lamination method, thereby improving the usage feeling such as drawability of the back pocket even while removing wrinkles caused by the rubber band or the like.

The intermediate layer 20 may have a density of about 26 to 39.9 kg/m³, a tensile strength of about 80 kPa or greater to about 150 kPa or less, and an elongation of about 90% or greater to about 150% or less. When the density is less than about 26 kg/m³, the size of the urethane pore may be increased, thereby tearing the intermediate layer 20 when used for the component, and there is a concern of generating non-beam noise or the like. When the density is greater than about 39.9 kg/m³, the usability may be decreased by a decrease in the elongation of the bonded skin layer. Further, when the tensile strength is less than about 80 kPa, there is a concern of causing a durability problem when used for the component, and when the tensile strength is greater than about 150 kPa, the usability is decreased by a decrease in the elongation of the bonded skin layer by the excessive strength to the intermediate layer. Further, when the elongation is less than about 90%, the usability may be decreased by a decrease in the elongation of the bonded skin layer, and when the elongation is greater than about 150%, sagging may occur when the object is mounted to the back pocket.

(3) Leather Sheet Layer

The leather sheet layer 30 may be positioned on the intermediate layer 20, and the leather sheet layer may include the fiber layer 31, and the skin surface layer 32 which is positioned on the fiber layer 31. Further, the skin surface layer 32 may include a skin layer 321, and preferably, may further include a foam layer 322 which is positioned between the skin layer 321 and the fiber layer 31, and a surface treatment layer 323 which is positioned on the skin layer 321.

The fiber layer 31 may be a layer which most affects the mechanical properties of the laminated sheet 1 for the vehicle interior material, and is not largely limited as long as the elongation in the fastening direction is greater than that in a direction perpendicular to the fastening direction. The fiber layer 31 may contain a mixed fiber containing poly trimethylene terephthalate (PTT) and poly ethylene terephthalate (PET). The mixed fiber may be composite spinning. A mass ratio of PTT:PET contained in the mixed fiber may be about 1:1 to 1.25. When the mass ratio is less than about 1:1, the usage feeling of the component may be decreased by a decrease in the elongation, and when the mass ratio is greater than about 1:1.25, the cost may increase and durability of the back pocket may be decreased by excessive elongation. For example, since the fiber layer 31 contains the mixed fiber consisting of a double-composite yarn of PTT and PET, the fiber layer 31 may largely improve the physical elasticity and a sense of restoration of the laminated sheet 1 for the vehicle interior material. Meanwhile, the knitting density of the fiber layer 31 refers to the number of knitted noses included in a unit inch. At this time, as the knitting density is less, a space in which the fiber contained in the fiber layer 31 may be stretched is widened, thereby improving the elongation. Accordingly, the knitting density of the fiber layer 31 may be about 30 to 35 pieces/inch. When the knitting density is less than about 30 pieces/inch, a recovery rate after stretched may be decreased, and when the knitting density is greater than about 35 pieces/inch, a peeling strength may be increased by an the increase in the surface area of the fiber layer 31 to be bonded to the elastomer foam layer which is the intermediate layer, thereby decreasing the elongation of a final composite product to decrease the usage feeling.

The skin surface layer 32 may include the skin layer 321, and preferably, may further include the foam layer 322 which is positioned between the skin layer 321 and the fiber layer 31, and the surface treatment layer 323 which is positioned on the skin layer 321.

A liquid resin may be applied to the skin layer 321 in a casting method. The liquid resin may include one or more types of resins selected from the group consisting of typical resins which may be used, for example, a polyvinyl chloride (PVC) resin and a polyurethane (PU) resin, and is not limited to including a specific resin, but may be preferably a PVC liquid resin which may process the skin layer in a thickness of about 0.15 to 0.5 mm, thereby securing durability of the component and is cost-competitive. When the skin layer 321 is manufactured by applying the casting method, flexibility may be provided to the laminated sheet 1 for the vehicle interior material. Further, the surface treatment layer 323 may preferably contain a polyurethane-based surface treatment agent for the vehicle interior material, which may satisfy durability and color fastness to light, as a typical material which may be used in the present invention.

The leather sheet layer 30 including the fiber layer 31 and the skin surface layer 32 may have a thickness of about 1.2 to 1.5 mm, a static load elongation of about 80% or greater and about 110% or less, and a tear strength of about 1.5 kgf or greater and about 5.0 kgf or less. When the thickness is less than about 1.2 mm, sagging and breakage in a component state may occur due to lack of the strength as the vehicle interior material, and when the thickness is greater than about 1.5 mm, workability may be poor and a stepped portion from a plastic fastening part may be generated when the back pocket is fastened to a sheet backboard plastic. Further, when the static load elongation is less than about 80%, the usability of the back pocket component may be decreased, and when the static load elongation is greater than about 110%, not only the shape stability of the component may be insufficient, but also there is reached a limitation which may not be manufactured with a material applicable as the skin layer. Further, when the tear strength is less than about 1.5 kgf, breakage may occur when pulled for using the back pocket component, and when the tear strength is greater than about 5 kgf, the elongation may be decreased by the excessive strength, thereby decreasing the usability of the component.

For example, the laminated sheet 1 for the vehicle interior material may include the backing cloth layer 10 which contains the fiber having an adjusted diameter; the intermediate layer 20 which contains elastomer foam and bonds the backing cloth layer 10 and the fiber layer 31 below in a flame lamination method; and a leather sheet layer 30 which includes the skin surface layer 32 composed of the skin layer 321 made of a liquid resin by using a casting method, and the fiber layer 31 which contains a mixed fiber having a high-stretch property. As such, the laminated sheet may not only provide flexibility to the laminated sheet 1 for the vehicle interior material but also effect of decreasing the peeling strength, and the usage feeling such as drawability of the back pocket may be improved even while removing wrinkles caused by the rubber band by not containing the rubber band or the like.

Accordingly, the laminated sheet 1 for the vehicle interior material may have ‘a load upon 15% elongation’ of 1.0 kgf or greater and about 1.9 kgf or less objectively quantified in order to confirm the usage feeling of the back pocket capable of using the laminated sheet 1 for the vehicle interior material, a peeling strength between the leather sheet layer 30 and the intermediate layer 20 of about 0.1 kgf or greater and about 0.4 kgf or less, and a static load elongation of about 80 to 100%. When the ‘load upon 15% elongation’ is less than 1.0 kgf, the laminated sheet 1 for the vehicle interior material may be easily stretched, such that sagging easily may occur when the object is mounted to the back pocket. Further, when the ‘load upon 15% elongation’ is greater than about 1.9 kgf, the usability may be decreased, thereby decreasing the elasticity of the component. Further, when the peeling strength is less than about 0.1 kgf, the constituent materials of the laminated sheet may be easily separated, thereby having durability insufficient as the vehicle interior material, and when the peeling strength is greater than about 0.4 kgf, the elastomer layer, which is an intermediate layer, may act as an inhibitory factor in the stretch of the skin layer, thereby not reaching a target elongation. Further, when the static load elongation is less than about 80%, the usability of the component may be decreased, and when the static load elongation is greater than about 100%, the laminated sheet 1 for the vehicle interior material may be easily stretched, such that sagging easily occurs when the object is mounted to the back pocket.

Method for Manufacturing the Laminated Sheet for the Vehicle Interior Material

FIG. 2 shows a flowchart of an exemplary method for manufacturing the laminated sheet 1 for the vehicle interior material according to an exemplary embodiment of the present invention. As shown in FIG. 2, the method may include preparing the intermediate layer 20 (S10), forming the backing cloth layer 10 on one surface of the intermediate layer 20 (S20), and forming the leather sheet layer 30 on the other surface of the intermediate layer 20 (S30).

The preparing of the intermediate layer 20 (S10) is a step of preparing the intermediate layer 20 in order to manufacture the laminated sheet 1 for the vehicle interior material in a lamination method. A material contained in the intermediate layer 20 may be the same as or different from the above material. The lamination method may select one or more types selected from the group consisting of a flame lamination method, a thermoplastic PU lamination method, and a thermosetting PU lamination method, and is not limited to a specific method, but uses preferably the flame lamination method which may manufacture the laminated sheet 1 for the vehicle interior material with ‘the load upon 15% elongation’ of 1.9 kgf or less objectively quantified by the present invention in order to confirm the usage feeling such as drawability.

The forming of the backing cloth layer 10 (S20) is a step of forming the backing cloth layer 10 on one surface of the intermediate layer 20. The material contained in the backing cloth layer 10 may be the same as or different from the above material. The forming of the backing cloth layer 10 may bond the backing cloth layer on one surface of the intermediate layer in the flame lamination method. At this time, the flame lamination method may be performed at a speed of about 30 to 40 mm/min. When the flame lamination speed is less than about 30 mm/min, the bonded material is burnt or damaged by excessive heating, and there is a disadvantage in that when the flame lamination speed is greater than about 40 mm/min, the bonded material may be peeled by lack of the peeling strength.

The forming of the leather sheet layer 30 (S30) is a step of forming the leather sheet layer 30 on the other surface of the intermediate layer 20 rather than one surface on which the backing cloth layer 10 is formed. The leather sheet layer 30 may be prepared by a step of preparing the fiber layer 31, and a step of forming the skin surface layer 32 on the fiber layer 31. For example, the forming of the skin surface layer 32 may include forming the foam layer 322 on the fiber layer 31, forming the skin layer 321 on the foam layer 322 by applying a liquid resin in a casting method, and forming the surface treatment layer 323 by surface-treating the skin layer 321. The forming of the foam layer 322 on the fiber layer 31 may prepare the fiber layer 31 and the foam layer 322, respectively, which contain a material which may be the same as or different from the above material, and form the foam layer 322 on the fiber layer 31 in a typical method. The forming of the skin layer 321 may form the skin layer 321 by applying the liquid resin, preferably, the polyvinyl chloride (PVC) liquid resin in the casting method. At this time, the casting method may cast the PVC resin on the foam layer in a thickness of about 0.15 to 0.50 mm, and the particle size of the PVC may be about 0.2 to 20 μm. When the thickness of the skin layer is about 0.15 mm or less, the properties of the PVC contained in the skin layer are decreased as compared to the durability required for the vehicle interior material, and when the thickness of the skin layer is greater than about 0.5 mm, workability may be poor and a stepped portion from the plastic fastening part may occur when the back pocket is fastened to the sheet backboard plastic. Further, when the particle size of the PVC is less than about 0.2 μm, the properties may be decreased as compared to the durability required for the vehicle interior material, and when the particle size of the PVC is greater than about 20 μm, the elongation characteristics required for the back pocket component may not be satisfied. The laminated sheet for the vehicle interior material may include the skin surface layer composed of the skin layer made of the liquid resin by using the casting method, thereby providing flexibility to the laminated sheet.

The forming of the surface treatment layer 323 is a step of forming the surface treatment layer 323 by surface-treating the skin layer 321. The skin layer 321 may be surface-treated with a material which is the same as or different from the aforementioned material, the surface treatment method may perform the treatment with a typical treatment method, for example, polyurethane-based surface treatment agent, silicone-based surface treatment agent, or the like, and is not limited to a specific method, but preferably, may perform the treatment by using a polyurethane-based surface treatment agent for the vehicle interior material which satisfies durability. After the backing cloth layer 10 is formed on the intermediate layer 20 in the flame lamination method, the prepared leather sheet layer 30, or particularly, the fiber layer 31 in the leather sheet layer 30 may be formed on the other surface of the intermediate layer 20 in the flame lamination method. At this time, the flame lamination method may be performed at a speed of about 30 to 40 mm/min. When the flame lamination speed is less than about 30 mm/min, the bonded material may be burnt or damaged by excessive heating. When the flame lamination speed is greater than about 40 mm/min, the bonded material may be peeled by lack of the peeling strength.

The method for manufacturing the laminated sheet for the vehicle interior material may not only include the skin surface layer composed of the skin layer made of the liquid resin by using the casting method, thereby providing flexibility to the laminated sheet, but also include the leather sheet layer and the intermediate layer which are bonded by using the flame lamination method, thereby decreasing the peeling strength of the laminated sheet. Accordingly, the laminated sheet for the vehicle interior material manufactured by the above feature may be manufactured with ‘the load upon 15% elongation’ of 1.9 kgf or less objectively quantified by the present invention in order to confirm the usage feeling of the back pocket, thereby improving the usage feeling such as drawability of the back pocket even while removing wrinkles caused by the rubber band by not containing the rubber band or the like.

### EXAMPLE

The present invention will be described in more detail through the following Example. The following Example is only an example for helping the understanding of the present invention, and the scope of the present invention is not limited thereto.

### Example: Laminated Sheet for the Vehicle Interior Material

(S10) The intermediate layer 20 was prepared with foam (tensile strength of 80 to 150 kPa) containing polyurethane (PU).

(S20) The backing cloth layer 10 was prepared, which contains a yarn component of the mass ratio of PTT:PET of 1:1 to 1.25, and has a thickness of 15 denier, a thickness of 0.3 to 0.8 mm, a knitting density of 30 to 35 pieces/inch, and an elongation of 100 to 150%. Then, the backing cloth layer 10 was bonded to one surface of the prepared intermediate layer 20 in the flame lamination method. At this time, the conditions of the flame lamination method were 30 to 40 mm/min and the like.

(S30) First, the leather sheet layer 30 was prepared, and then the leather sheet layer 30 was bonded to the other surface of the intermediate layer 20 in the flame lamination method, thereby manufacturing the laminated sheet 1 for the vehicle interior material. Specifically, the leather sheet layer 30 was prepared as follows. First, the fiber layer 31 was prepared with a high-stretch yarn in which poly trimethylene terephthalate (PTT) and poly ethylene terephthalate (PET) were mixed at a mass ratio of 1:1 in a double composite spinning method. At this time, a knitting density of the high-stretch yarn contained in the fiber layer 31 was 30 pieces/inch. Then, the skin layer 321 was formed by coating and then foaming the polyvinyl chloride (PVC) liquid resin on the foam layer 322 in the casting method. At this time, the conditions of the casting method were conditions such as the use of the PVC raw material having the particle size of 0.2 to 20 μm and a thickness of 0.15 to 0.50 mm. Then, the surface treatment layer 323 was manufactured on the skin layer 321 by being treated with a polyurethane-based surface treatment agent in a spray coating method. The leather sheet layer 30, which has a thickness of 3.2 to 4.0 mm, a static load elongation of 80 to 110%, and a tear strength of 1.5 to 5.0 kgf, was finally manufactured in the above method. Then, the leather sheet layer 30 was bonded to the other surface of the intermediate layer 20 in the flame lamination method. At this time, the conditions of the flame lamination method were 30 to 40 mm/min and the like.

### Comparative Example 1: Sheet for the Vehicle Interior Material

When compared to Example 1, the laminated sheet for the vehicle interior material was manufactured in the same manner as in Example 1, except that the skin layer 321 included in the leather sheet layer 30 was manufactured by performing a calendar method rather than the casting method.

### Comparative Example 2-1: Sheet for the Vehicle Interior Material

When compared with Example 1, the laminated sheet for the vehicle interior material was manufactured in the same manner as in Example 1, except that the fiber layer 31 included in the leather sheet layer 30 was prepared by containing PET 100% A (DTY 75 denier; double knit) rather than a high-stretch yarn.

### Comparative Example 2-2: Sheet for the Vehicle Interior Material

When compared with Comparative Example 1, the laminated sheet for the vehicle interior material was manufactured in the same manner as in Comparative Example 1, except that the fiber layer 31 included in the leather sheet layer 30 was prepared by containing PET 100% A (DTY 75 denier; double knit) rather than the high-stretch yarn.

### Comparative Examples 3-1 to 3-7: Sheet for the Vehicle Interior Material

When compared with Comparative Example 1, the laminated sheet for the vehicle interior material was manufactured in the same manner as in Comparative Example 1, except that the fiber layer 31 included in the leather sheet layer 30 was prepared by containing cotton 100% (Comparative Example 3-1), PET 100% B (DTY 75 denier; interlock) (Comparative Example 3-2), PET 100% C (DTY 75 denier; terry) (Comparative Example 3-3), PET 100% D (DTY 150 denier) (Comparative Example 3-4), PET 100% E (STY 75 denier) (Comparative Example 3-5), PET+cotton B (DTY 150 denier+30 cottons) (Comparative Example 3-6), or PET+cotton A (DTY 100 denier+30 cottons) (Comparative Example 3-7) rather than the high-stretch yarn.

### Comparative Examples 4-1 and 4-2: Sheet for the Vehicle Interior Material

When compared with Example 1, the laminated sheet for the vehicle interior material was manufactured in the same manner as in Example 1, except that the backing cloth layer 10 and the leather sheet layer 30 were bonded to each of one surface and the other surface of the intermediate layer 20 by performing the thermoplastic PU method under the temperature condition of 90 to 105° C. (Comparative Example 4-1) or performing the thermosetting PU method under the moisture curing condition at the room temperature of 23 to 25° C. (Comparative Example 4-2) rather than the flame lamination method.

### Comparative Examples 5-1 and 5-2: Sheet for the Vehicle Interior Material

When compared with Example 1, the laminated sheet for the vehicle interior material was manufactured in the same manner as in Example 1, except that the fiber layer 31 included in the leather sheet layer 30 was prepared by containing a general material (PET 100% or cotton 100%) rather than the high-stretch yarn (Comparative Example 5-1), and further, prepared to contain the fiber having a thickness of the backing cloth layer 10 of 50 denier (Comparative Example 5-2).

Method for Measuring Properties

(1) Peeling strength: the method measures the load required to peel in a state where the sheet for the vehicle interior material and the intermediate layer elastomer polyurethane foam were bonded, and specifically measures the load required to additionally peel the specimen by 50 mm by forcibly peeling the specimen having a width of 30 mm and a length of 150 mm by 50 mm in length and then stretching the specimen at the tensile speed of 200 mm/min.

(2) Static load elongation: the method measures the rate % at which the sheet for the vehicle interior material is stretched when the load of 8 kg is applied to the sheet for the vehicle interior material for 10 minutes, and specifically measures the deformed length of the specimen having a width of 50 mm and a length of 250 mm after 10 minutes under a clamp interval of 150 mm and a gauge length of 100 mm.

(3) Load upon 15% elongation: the method confirms that the laminated sheet for the vehicle interior material is stretched by 13.6% to 16% based on an opening amount of 110 mm, confirms that the 15% elongation is suitable as a reference objectively quantified by the present invention in order to confirm the usage feeling of the back pocket, and uses the above contents as a reference. This means that as the load upon 15% elongation is less, the sheet may be stretched up to the 15% elongation even with a less force. This is because even if the static load elongation is the same, the usage feeling such as opening feeling or drawability is not satisfied in the sheet state evaluation, thereby not representing the usage feeling of a general user. Accordingly, since the pre-verification is possible in the sheet specimen state before producing the sheet, the cost for verifying the component may be decreased.

(4) Operating force: the method records the load required when pulled by 70 mm by mounting the push-pull gauge to the center of the back pocket component.

### Experimental Example 1: Comparison of the Loads Upon 15% Elongation of the Laminated Sheet Specimens for the Vehicle Interior Material Due to Differences in the Materials of the Fiber Layer and the Methods for Manufacturing the Skin Layer

The laminated sheet specimens for the vehicle interior material were manufactured according to Example 1, Comparative Example 1, Comparative Example 2-1, Comparative Example 2-2, and Comparative Examples 3-1 to 3-7, and the loads upon 15% elongation were compared and the results thereof are shown in Table 1 below.

TABLE 1
Example and

| Comparative | Skin layer | Fiber layer | Load per certain elongation (kgf) | | | | |
|---|---|---|---|---|---|---|---|
| Examples | method | material | 15% | 30% | 50% | 80% | 100% |
| Example | Casting | High-stretch | 1.89 | 2.59 | 6.99 | 12.4 | 18.44 |
| | | yarn (knitting | | | | | |
| | | density 30) | | | | | |
| Comparative | Calendar | High-stretch | 5.68 | 7.06 | 14.39 | 22.3 | 29 |
| Example 1 | | yarn (knitting | | | | | |
| | | density 30) | | | | | |
| Comparative | Casting | PET100%_A | 1.76 | 2.39 | 5.69 | 8.38 | 10.12 |
| Example 2-1 | | | | | | | |
| Comparative | Calendar | PET100%_A | 6.24 | 7.4 | 12.1 | 15.8 | 18.2 |
| Example 2-2 | | | | | | | |
| Comparative | Calendar | cotton100% | 3.22 | 6.22 | 8.62 | 11.8 | 13.6 |
| Example 3-1 | | | | | | | |
| Comparative | Calendar | PET100%_B | 2.93 | 5.3 | 7.66 | 10.59 | 12.32 |
| Example 3-2 | | | | | | | |
| Comparative | Calendar | PET100%_C | 5.22 | 9.57 | 15.53 | 29.31 | 33.88 |
| Example 3-3 | | | | | | | |
| Comparative | Calendar | PET100%_D | 4.44 | 8.76 | 14.45 | 28.72 | 37.01 |
| Example 3-4 | | | | | | | |
| Comparative | Calendar | PET100%_E | 3.38 | 5.94 | 8.67 | 12.07 | 14.36 |
| Example 3-5 | | | | | | | |
| Comparative | Calendar | PET + cotton | 5.17 | 7.9 | 10.6 | 14 | 16.06 |
| Example 3-6 | | B | | | | | |
| Comparative | Calendar | PET + cotton | 6.78 | 13.81 | 23.38 | 44.41 | 53.63 |
| Example 3-7 | | A | | | | | |

As shown in Table 1, it may be confirmed that even if the fiber layer materials are the same in Example, Comparative Example 1, and Comparative Examples 2-1 and 2-2, ‘the load upon 15% elongation’ is greater when the skin layer method uses the calendar method. Further, when comparing the Example with Comparative Examples 3-1 to 3-7, it may be confirmed that the skin layer is manufactured in the casting method, and ‘the load upon 15% elongation’ is relatively less in the laminated sheet specimen for the vehicle interior material in which the fiber layer material is prepared with the high-stretch yarn. Accordingly, the laminated sheet for the vehicle interior material according to the present invention is characterized by not only including the skin surface layer composed of the skin layer made of the liquid resin by using the casting method, thereby providing flexibility to the laminated sheet, but also containing the high-stretch yarn containing PTT and PET in the fiber layer, thereby improving the usage feeling such as opening amount or drawability by providing elasticity.

### Experimental Example 2: Comparison of the Loads Upon 15% Elongation, the Static Load Elongations, and the Peeling Strengths of the Laminated Sheet Specimens for the Vehicle Interior Material According to the Lamination Methods Between the Leather Sheet Layer and the Intermediate Layer

The laminated sheet specimens for the vehicle interior material were manufactured according to Example 1, and Comparative Examples 4-1 and 4-2, and the loads upon 15% elongation, the static load elongations, and the peeling strengths were compared and the results thereof are shown in Table 2 below.

TABLE 2

| | | | | | Peeling strength | | |
|---|---|---|---|---|---|---|---|
| | | | | | between leather | | |
| | | | | | sheet and | Static load elongation | |
| | Lamination | Skin layer | Fiber layer | Knitting density of fiber | intermediate | Basic fabric | Lamination |
| | method | method | material | layer (pieces/inch) | layer | (%) | (%) |
| Example | Flame | Casting | High-stretch | 30 | 0.35 | 82 | 80 |
| | | | yarn | | | | |
| Comparative | Thermoplastic | Casting | High-stretch | 30 | 0.56 | 82 | 74 |
| Example | PU | | yarn | | | | |
| 4-1 | | | | | | | |
| Comparative | Thermosetting | Casting | High-stretch | 30 | Peeling | 82 | 78 |
| Example | PU | | yarn | | impossible (Max) | | |
| 4-2 | | | | | | | |

| | Load upon certain elongation (kgf) | | | | | | | Operating |
|---|---|---|---|---|---|---|---|---|
| | (after lamination method) | | | | | | Opening amount | force |
| | 10% | 15% | 20% | 50% | 80% | 100% | (mm) | (kgf) |
| Example | 1.23 | 1.89 | 2.59 | 6.99 | 12.4 | 18.44 | 110 | 13 |
| Comparative | 3.79 | 5.95 | 8.04 | 7.22 | 12.58 | 18.9 | Dissatisfaction | Dissatisfaction |
| Example | | | | | | | | |
| 4-1 | | | | | | | | |
| Comparative | 1.5 | 2.32 | 3.15 | 7.86 | 15.43 | 24.12 | Dissatisfaction | Dissatisfaction |
| Example | | | | | | | | |
| 4-2 | | | | | | | | |

As shown in Table 2, it may be confirmed that the load upon 15% elongation is the lowest in the sheet specimen of Example, the opening amount is also satisfied, and the operating force is also satisfied. That is, it may be confirmed that the size of the peeling strength is decreased in the order of the thermosetting PU lamination method, the thermoplastic PU lamination method, and the flame lamination method, and as a result, it may be confirmed that the static load elongation and a change in the load upon certain elongation are changed after the lamination method. It may be confirmed that this eventually serves as holding the sheet specimen so as not to be sagged as the peeling strength increases. Accordingly, the laminated sheet for the vehicle interior material according to the present invention is characterized by including the leather sheet layer and the intermediate layer which are bonded in the flame lamination method to decrease the peeling strength of the laminated sheet, thereby improving the usage feeling such as opening amount or drawability.

### Experimental Example 3: Comparison of the Loads Upon 15% Elongation, the Static Load Elongations, and the Peeling Strengths According to the Lamination Methods Between the Leather Sheet Layer and the Intermediate Layer

The laminated sheet specimens for the vehicle interior material were manufactured according to Example 1, and Comparative Examples 5-1 and 5-2, and the loads upon 15% elongation, the static load elongations and the peeling strengths were compared and the results thereof are shown in Table 3 below.

TABLE 3

| | | | | | Peeling strength | | |
|---|---|---|---|---|---|---|---|
| | | | | | between leather | | |
| | | | | Backing cloth layer | sheet and | Static load elongation | |
| | Lamination | Skin layer | Fiber layer | fiber thickness | intermediate | Basic fabric | Lamination |
| | method | method | material | (denier) | layer | (%) | (%) |
| Example | Flame | Casting | High-stretch | 15 | 0.35 | 82 | 80 |
| | | | yarn | | | | |
| Comparative | Flame | Casting | General | 15 | 0.35 | 107 | 78 |
| Example | | | | | | | |
| 5-1 | | | | | | | |
| Comparative | Flame | Casting | General | 50 | 0.35 | 107 | 68 |
| Example | | | | | | | |
| 5-2 | | | | | | | |

| | | |
|---|---|---|
| Load upon certain elongation (kgf) | | Operating |
| (after lamination method) | Opening amount | force |

| | 10% | 15% | 20% | 50% | 80% | 100% | (mm) | (kgf) |
|---|---|---|---|---|---|---|---|---|
| Example | 1.23 | 1.89 | 2.59 | 6.99 | 12.4 | 18.44 | 110 | 13 |
| Comparative | 1.19 | 1.93 | 2.83 | 6.77 | 10.47 | 13.97 | 95 | 13.4 |
| Example | | | | | | | | |
| 5-1 | | | | | | | | |
| Comparative | 1.23 | 2.07 | 2.91 | 6.89 | 10.63 | 14.27 | 90 | 16 |
| Example | | | | | | | | |
| 5-2 | | | | | | | | |

As shown in Table 3, it may be confirmed that in Comparative Example 5-1 in which the fiber layer material is general, and the thickness of the fiber contained in the backing cloth layer is the same as that in Example 1, the load upon 15% elongation is greater than that in Example 1, and the opening amount is also insufficient. Further, it may be confirmed that in Comparative Example 5-2 in which the fiber layer material is general, and the thickness of the fiber contained in the backing cloth layer includes 50 denier thicker than that in Example 1, the load upon 15% elongation is greater than those in Example 1 and Comparative Example 5-2, and the opening amount is also less sufficient than that in Comparative Example 5-2. Accordingly, it may be confirmed that a change in the elongation of the sheet specimen is changed depending on the fiber layer material and the thickness of the fiber contained in the backing cloth layer. That is, it may be confirmed that as the density of the backing cloth layer is increased by thickening the fiber contained in the backing cloth layer, the elongation in the direction of fastening the sheet specimen is decreased, such that the thickness of the fiber contained in the backing cloth layer is suitably about 15 denier. That is, the laminated sheet for the vehicle interior material, which includes the fiber layer containing the material of the high-stretch yarn, and the backing cloth layer composed of the fiber with the thickness adjusted to an appropriate size, is characterized by adjusting the elongation of the sheet specimen to ‘the load upon 15% elongation’ of 1.9 kgf or less objectively quantified by the present invention, thereby improving the usage feeling such as opening amount or drawability.

What is claimed is:

1. A laminated sheet for a vehicle interior material comprising:
a backing cloth layer;
an intermediate layer which is positioned on the backing cloth layer and comprises an elastomer foam; and
a leather sheet layer which is positioned on the intermediate layer,
wherein the leather sheet layer comprises a fiber layer, and a skin surface layer which is positioned on the fiber layer.

2. The laminated sheet of claim 1,
wherein the fiber layer comprises a mixed fiber comprising one or more types selected from the group consisting of poly trimethylene terephthalate (PTT) and poly ethylene terephthalate (PET).

3. The laminated sheet of claim 2,
wherein the fiber layer comprises the mixed fiber having a mass ratio of the PTT and the PET of 1:1 to 1.25.

4. The laminated sheet of claim 2,
wherein the fiber layer has a knitting density of 30 to 35 pieces/inch.

5. The laminated sheet of claim 1,
wherein the skin surface layer comprises a skin layer to which a polyvinyl chloride (PVC) resin is applied.

6. The laminated sheet of claim 5,
wherein the skin surface layer further comprises a foam layer which is positioned between the skin layer and the fiber layer and a surface treatment layer which is positioned on the skin layer.

7. The laminated sheet of claim 1,
wherein the leather sheet layer has a thickness of 1.2 to 1.5 mm, a static load elongation of 80% or greater, and a tear strength of 1.5 kgf or greater.

8. The laminated sheet of claim 1,
wherein the elastomer foam comprises one or more types of resins selected from the group consisting of polyurethane (PU) and polypropylene (PP).

9. The laminated sheet of claim 1,
wherein the intermediate layer has a density of 26 to 39.9 kg/m³, a tensile strength of 80 kPa or greater, and an elongation of 90% or greater.

10. The laminated sheet of claim 1,
wherein the backing cloth layer comprises one or more types of fibers selected from the group consisting of polyester and cotton.

11. The laminated sheet of claim 10,
wherein the thickness of the fiber is 10 to 20 denier.

12. The laminated sheet of claim 1,
wherein the backing cloth layer has a thickness of 0.3 to 0.8 mm, a knitting density of 20 to 35 pieces/inch, and an elongation of 100% or greater.

13. The laminated sheet of claim 1, further comprising a flame lamination bonding layer between the backing cloth layer and the intermediate layer.

14. The laminated sheet of claim 1, having a load upon 15% elongation of 1.9 kgf or less, a static load elongation of 80 to 100%, and a peeling strength between the leather sheet layer and the intermediate layer of 0.4 kgf or less.
A vehicle interior material comprising a laminated sheet of claim 1.

15. A method for manufacturing a laminated sheet for a vehicle interior material, comprising:
preparing an intermediate layer;
forming a backing cloth layer on one surface of the intermediate layer; and
forming a leather sheet layer on the other surface of the intermediate layer,
wherein the leather sheet layer is prepared by a step of preparing a fiber layer and a step of forming a skin surface layer on the fiber layer.

16. The method of claim 16, wherein the forming of the skin surface layer comprises:
forming a foam layer on the fiber layer;
forming a skin layer on the foam layer by applying a polyvinyl chloride (PVC) resin in a casting method; and
forming a surface treatment layer by surface-treating the skin layer with a polyurethane-based surface treatment agent.

17. The method of claim 17, wherein the casting method casts the PVC resin on the foam layer in a thickness of 0.15 to 0.50 mm, and the particle size of the PVC is 0.2 to 20 μm.

18. The method of claim 16, wherein the forming of the backing cloth layer on one surface of the intermediate layer forms a flame lamination bonding layer on one surface of the intermediate layer in a flame lamination method to bond the backing cloth layer.

19. The method of claim 16, wherein the forming of the leather sheet layer on the other surface of the intermediate layer bonds the leather sheet layer on the other surface of the intermediate layer in a flame lamination method.
